(19) United States
(12) Patent Application Publication
(10) Pub. No.: US 2025/0385028 A1
(43) Pub. Date: Dec. 18, 2025

(54) RARE EARTH MAGNET

(71) Applicant: MINEBEA MITSUMI Inc., Kitasaku-gun, Nagano (JP)

(72) Inventors: Yu OKAWARA, Kitasaku-gun, Nagano (JP); Haruhiro KOMURA, Kitasaku-gun, Nagano (JP)

(21) Appl. No.: 18/878,151

(22) PCT Filed: Apr. 14, 2023
(86) PCT No.: PCT/JP2023/015134

§ 371 Date: Dec. 23, 2024

(30) Foreign Application Priority Data
Jun. 30, 2022 (JP) 2022-105949

(51) Int. Cl. H01F 1/057

(52) U.S. Cl. CPC H01F 1/0577

(57) ABSTRACT

Provided is a rare earth magnet obtained by subjecting an R—Fe—B-based alloy containing R, wherein R represents a rare earth element containing Nd, Fe, and B to hot plastic processing. The rare earth magnet has a structure of a main phase containing an R₂Fe₁₄B compound, an axis of easy magnetization is oriented in a minor axis direction of a crystal grain of the main phase, a thickness dimension in a direction of the axis of easy magnetization is from 0.07 mm to 0.2 mm, and a decrease rate of residual magnetization is 5% or less, wherein the decrease rate (%) of residual magnetization is a rate of decrease in residual magnetization with respect to when residual magnetization of the rare earth magnet having the thickness dimension of 0.5 mm is defined as 100%.

### CROSS REFERENCE TO RELATED APPLICATIONS

This application is a national stage entry of International Application No. PCT/JP2023/015134, filed on Apr. 14, 2023, which claims priority to Japanese Patent Application 2022-105949, filed on Jun. 30, 2022, which is incorporated herein by reference.

### TECHNICAL FIELD

The disclosure relates to a rare earth magnet.

### BACKGROUND

Nd—Fe—B-based permanent magnets are excellent in magnetic properties, and thus are used in computer-related devices, various electronic devices, home electric appliances, and various actuators. In recent years, these electronic devices, home electric appliances, various actuators, and the like are required to have a reduced size and a reduced thickness, and it is desirable to reduce the size and thickness of sintered magnets excellent in particular in magnetic properties among Nd—Fe—B-based permanent magnets.

In the related art, in a case where the Nd—Fe—B-based sintered magnet is reduced in size and thickness, in general, a sintered block-shaped magnet is cut into a predetermined shape and then the surface needs to be ground to obtain a desired thickness; however, the magnetic properties of the sintered magnet are known to be deteriorated as the Nd—Fe—B-based sintered magnet is made to be thinner by grinding (See, for example, JP S62-192566 A).

JP S62-192566 A discloses that an alloy thin film layer containing at least one of Ti, W, Pt, Au, Cr, Ni, Cu, Co, Al, Ta, and Ag in an amount of from 1.0 atom % to 50.0 atom % and a balance R′ (R′ is at least one of Ce, La, Nd, Pr, Dy, Ho, and Tb) is formed on a surface to be ground of a sintered magnet body in order to prevent deterioration of magnetic properties caused by grinding.

### SUMMARY

However, JP S62-192566 A mentions that, as a method of joining the alloy thin film layer to the surface to be ground of the sintered magnet body, a thin film forming method such as vacuum vapor deposition, ion sputtering, ion plating, an ion vapor deposition thin film forming method, or a plasma vapor deposition thin film forming method can be appropriately selected and used, and after the alloy thin film layer is formed, a heat treatment from 400° C. to 900° C. for 1 minute or longer and 3 hours or shorter is required to be performed at least once in a vacuum or an inert atmosphere.

As described above, since after grinding the surface of the sintered magnet to a desired thickness, an additional working step is further required, workability is poor.

Accordingly, an object of the disclosure is to provide a high-performance rare earth magnet excellent in workability during manufacturing.

To solve the above-described problem and achieve the object, a rare earth magnet according to an aspect of the disclosure is a rare earth magnet obtained by subjecting an R—Fe—B-based alloy containing R, wherein R represents a rare earth element containing Nd, Fe, and B to hot plastic processing. The rare earth magnet has a structure of a main phase containing an R₂Fe₁₄B compound, an axis of easy magnetization is oriented in a minor axis direction of a crystal grain of the main phase, a thickness dimension in a direction of the axis of easy magnetization is from 0.07 mm to 0.2 mm, and a decrease rate of residual magnetization is 5% or less, wherein the decrease rate (%) of the residual magnetization is a rate of decrease in residual magnetization with respect to when residual magnetization of the rare earth magnet having the thickness dimension of 0.5 mm is defined as 100%.

According to one aspect of the disclosure, a high-performance rare earth magnet excellent in workability during manufacturing is obtained.

### BRIEF DESCRIPTION OF DRAWINGS

FIG. 1 is a diagram schematically illustrating a cross-sectional view of a rare earth magnet in a thickness direction according to an embodiment.

FIG. 2 is a diagram schematically illustrating a cross-sectional view of a rare earth magnet in a thickness direction, and the rare earth magnet is obtained when processing a surface parallel to a thickness direction of a flat plate in a grinding step.

FIG. 3 is a diagram schematically illustrating a cross-sectional view of a Nd sintered magnet in a thickness direction after the Nd sintered magnet is subjected to a grinding step.

FIG. 4 is a diagram showing demagnetization curves of test pieces of Example.

FIG. 5 is a diagram showing demagnetization curves of test pieces of Comparative Example (test pieces produced by using Sample A).

FIG. 6 is a diagram showing demagnetization curves of test pieces of Comparative Example (test pieces produced by using Sample B).

### DESCRIPTION OF EMBODIMENTS

An embodiment according to the disclosure will be described below in detail with reference to the drawings. Note that the invention is not limited to the embodiments. Components in the following embodiment include components easily replaceable by a person skilled in the art or substantially identical components.

The rare earth magnet (also referred to as a rare earth permanent magnet) according to the embodiment is a rare earth magnet obtained by subjecting an R—Fe—B-based alloy containing R (R represents a rare earth element containing Nd), Fe, and B to hot plastic processing. Specifically, the rare earth magnet can be produced by a method described below.

### Production of Rare Earth Magnet Powder

First, R—Fe—B-based magnet powder is prepared as rare earth magnet powder. The R—Fe—B-based magnet constituting the R—Fe—B (boron)-based magnet powder contains, as a main phase, an R₂Fe₁₄B phase (for example, an R₂Fe₁₄B-type compound phase) being a ternary tetragonal crystal compound. In addition, the R—Fe—B-based magnet usually further contains an R-rich phase and the like. R represents a rare earth element containing Nd. In other words, R contains Nd as an essential component. Examples of the rare earth element include, in addition to neodymium (Nd) and praseodymium (Pr), scandium (Sc), yttrium (Y), lanthanum (La), cerium (Ce), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu). One kind of the other rare earth elements may be used together with Nd, or two or more kinds of the other rare earth elements may be used in combination. As R, at least Nd is required to be used. Some of the Fe may be substituted with Co. In a case where some of the Fe are substituted with Co, Fe is preferably to be contained in an amount of 50 atom % or more when the total amount of Fe and Co is 100 atom %.

The R—Fe—B-based magnet may contain another element. Examples of the other elements include titanium (Ti), zirconium (Zr), niobium (Nb), molybdenum (Mo), hafnium (Hf), tantalum (Ta), and tungsten (W). The other elements may be used alone or in a combination of two or more. In the R—Fe—B-based magnet, R is preferably contained in an amount of from 12 atom % to 16 atom %. B is preferably contained in an amount of from 6 atomic % to 8 atomic %. When the other elements described above are contained, the other elements are preferably contained in an amount of more than 0 atomic % and 3 atomic % or less in total. Note that as used herein, the balance is the total amount of Fe and inevitably contained elements.

Here, as the R—Fe—B-based magnet, for example, an Nd—Fe—B-based magnet using an Nd—Fe—B-based alloy having Nd₂Fe₁₄B as a main phase will be described as an example.

The Nd—Fe—B-based magnet powder is manufactured by, for example, a rapid quenching method (melt span method). Specifically, the Nd—Fe—B-based alloy is melted by high-frequency induction heating under reduced pressure or in an argon atmosphere. Subsequently, the molten metal of the melted alloy is sprayed onto a rotating roll made of copper and is subjected to rapid quenching (rapid cooling) to produce a ribbon-shaped thin strip. The thin strip is then crushed. For example, preferably the thin strip is broken into pieces of about several mm to several tens mm, and then crushed by a crusher or the like. The thin strip is crushed to obtain a crushed powder.

The ribbon-shaped thin strip is crushed to obtain a crushed powder, and the crushed powder is subjected to heat treatment to obtain a magnet powder. At this stage, since the direction of the axes of easy magnetization of the crystal grains of the magnet powder are not aligned in one direction, the magnet powder is magnetically isotropic. Note that a premanufactured magnet powder can be used as a substitute instead of actual manufacturing of the magnet powder. For example, a magnetically isotropic magnet powder obtained by crushing the Nd—Fe—B-based thin strip produced by the rapid quenching method is provided from Magnequench International, LLC as magnet powder with increased density by hot press molding.

### Hot Press Step: Production of Sintered Magnet Body

Subsequently, a first mold is prepared. The first mold includes a hollow cylindrical die, a hollow cylindrical upper punch and lower punch inserted inside the die, and a cylindrical core disposed inside the upper punch and the lower punch. The die, the upper punch, the lower punch, and the core are formed of an electroconductive material (such as graphite, cemented carbide, or the like).

Subsequently, the first mold is filled with a rare earth magnet powder (Nd—Fe—B-based magnet powder), and is set in a sintering apparatus (SPS apparatus: discharge plasma sintering apparatus) and sintered, and the sintered magnet body (hot press magnet body) is taken out from the first mold.

The magnet powder filled in the cavity of the first mold is pressurized with the upper punch and the lower punch by the pressure applied between an upper electrode and a lower electrode. Furthermore, a current flows from the upper electrode to the upper punch, flows through the die, the core, and the magnet powder, and flows through the lower punch to the lower electrode, and this causes Joule heat to be generated and discharge plasma to be generated in the magnet powder to heat the magnet powder. For example, the magnet powder is heated to a temperature from 600 to 700° C. under pressure from 30 to 50 MPa (hot press). In addition, sintering is preferably performed in an inert atmosphere under reduced pressure, and specifically, sintering is preferably performed in an argon or nitrogen atmosphere.

After heating, the current is interrupted, and cooling takes place. After being cooled down to a predetermined temperature, the first mold is taken out from the sintering apparatus. Specifically, a ring-shaped sintered magnet body formed through sintering of the magnet powder is taken out from the first mold. The ring-shaped sintered magnet body in this state has, for example, an outer diameter Φ of 30 mm×an inner diameter Φ of 15 mm×a thickness of 10 mm, and has a relative density of about 90%, the orientations of the axes of easy magnetization of the crystal grains in the ring-shaped sintered magnet body are random, and the ring-shaped sintered magnet body is magnetically isotropic.

### Hot Plastic Processing Step: Production of Hot-Deformed Magnet

Subsequently, a second mold is prepared. Note that the second mold may be prepared while preparing the first mold, or may be prepared prior to the preparation of the first mold.

The sintered magnet body produced in the above-described hot press step is set in the second mold, the second mold is set in a sintering apparatus, and hot plastic processing is performed.

In the sintering apparatus, an upper electrode is disposed at an upper end of the punch, and a lower electrode is disposed at a lower end of the die. The upper electrode and the lower electrode are formed of an electroconductive material (such as graphite, cemented carbide, or the like). The sintering apparatus includes a power supply device and a control device. The power supply device applies a predetermined voltage between the upper electrode and the lower electrode to supply a predetermined current. The sintering apparatus may also serve as a sintering apparatus in the hot press step described above, or may be another apparatus.

The sintered magnet body disposed between the die and the punch of the second mold is pressurized by the die and the punch. In addition, the sintered magnet body is heated by discharge plasma and Joule heat generated by a current flowing through the path from the upper electrode, via the punch, the sintered magnet body, and the die, to the lower electrode. In the hot plastic processing, a pressure from 30 to 100 MPa is applied, and then heating is started, for example, the sintered magnet body is pressurized while heated to a temperature from 600° C. to 700° C. During heating, ON-OFF DC pulse energization is carried out for the sintered magnet body. During the hot plastic processing, the pressure is desirably adjusted so that the processing speed does not increase, preferably, the processing speed is constant. The hot plastic processing is preferably performed under reduced pressure or in an inert atmosphere, specifically in an argon or nitrogen atmosphere. The hot plastic processing is preferably performed from the beginning of the displacement to the completion of the displacement while the displacement is monitored. Here, regarding the monitoring of the displacement, the displacement amount of a servo motor performing pressure control is usually monitored.

The crystal grain of the hot-deformed magnet by hot plastic processing has a flat shape, and the axis of easy magnetization of the crystal grain is oriented in a direction perpendicular to the flat surface of the crystal grain. The crystal grain during production of the thin strip by a rapid quenching method has an isotropic shape; however, the crystal grain grows into a flat shape by hot plastic processing, and the flat surfaces of the grains are mechanically aligned in the pressure direction. In other words, “the flat surfaces of the grains are mechanically aligned in the pressure direction” means that the axis of easy magnetization is aligned with the pressure direction (minor axis direction of the crystal grain). Accordingly, the axes of easy magnetization of the crystal grains in the magnet are aligned in the thickness direction of the hot-deformed magnet (sintered magnet body is changed to the hot-deformed magnet by the hot plastic processing). Note that a method of manufacturing an anisotropic magnet by so-called hot extrusion processing is applied to the hot-deformed magnet.

After the heating, the current is interrupted, and the sintering apparatus is cooled down. After being cooled down to a predetermined temperature, the second mold is taken out from the sintering apparatus, and a ring-shaped hot-deformed magnet obtained by subjecting the sintered magnet body to hot plastic processing is taken out from the second mold.

The hot-deformed magnet obtained by the hot plastic processing has magnetic anisotropy, and the shape of the hot-deformed magnet has, for example, an outer diameter Φ of 40 mm×an inner diameter Φ of 11 mm×a thickness of 3 mm, and the relative density of the hot-deformed magnet is almost the true density, and the magnetic properties are enhanced. The produced hot-deformed magnet has an average crystal grain size from 0.02 μm to 0.5 μm and a Curie point from 250° C. to 400° C.

### Grinding Step

The hot-deformed magnet obtained by the hot plastic processing is ground to have a predetermined shape. Specifically, the hot-deformed magnet subjected to hot processing is taken out from the apparatus, and the hot-deformed magnet is set in a wire cut machine and cut out into a predetermined shape. For example, the hot-deformed magnet is cut out into a flat plate having a size from 2 mm×2 mm square to 10 mm×10 mm square and a thickness from 1 mm to 5 mm. Here, the hot-deformed magnet is cut out so that the thickness direction of the flat plate is aligned with the thickness direction (pressure direction during production of the hot-deformed magnet, namely, direction of the axis of easy magnetization) of the hot-deformed magnet.

Next, both end faces (faces in a direction perpendicular to the thickness direction of the flat plate) of the cut out flat plate are ground with a plane grinder to obtain a desired thickness dimension. In other words, the thickness dimension after the grinding is from 0.07 mm to 0.2 mm, and preferably from 0.1 mm to 0.2 mm. Specifically, the grinding is performed only in the minor axis direction of the crystal grain having a flat shape in the hot-deformed magnet. The grinding is performed with, for example, a grindstone wheel made of a diamond grindstone or the like.

For example, since being obtained as described above, the rare earth magnet according to the embodiment has a structure of a main phase containing a R₂Fe₁₄B compound. The average crystal grain size of the main phase is preferably from 0.02 μm to 0.5 μm. In the rare earth magnet according to the embodiment, the axis of easy magnetization is oriented in the minor axis direction of the crystal grain of the main phase. Furthermore, the thickness dimension in the direction of the axis of easy magnetization is from 0.07 mm to 0.2 mm. Note that a flat plate having a size from 2 mm×2 mm square to 10 mm×10 mm square is preferable.

The rare earth magnet according to the embodiment has a decrease rate of residual magnetization of 5% or less. As described above, the rare earth magnet according to the embodiment has a reduced decrease rate of the residual magnetization, and thus, has high performance. Here, the decrease rate (%) of the residual magnetization is determined as follows. First, the residual magnetization when the thickness dimension of the rare earth magnet is 0.5 mm is measured. Note that the rare earth magnet having a thickness dimension of 0.5 mm can be specifically prepared as a sample having a thickness dimension adjusted to 0.5 mm in the grinding step of the rare earth magnet according to the embodiment. Subsequently, the residual magnetization of the rare earth magnet according to the embodiment is measured. Subsequently, with respect to when the residual magnetization of the rare earth magnet having a thickness dimension of 0.5 mm is defined as 100%, a rate of decrease in residual magnetization of the rare earth magnet according to the embodiment is determined. For example, in a case where the residual magnetization of the rare earth magnet according to the embodiment is 95% when the residual magnetization of the rare earth magnet having a thickness dimension of 0.5 mm is 100%, the decrease rate of the residual magnetization is 5% (100%−95%).

In the rare earth magnet according to the embodiment, the thickness dimension in the direction of the axis of easy magnetization is preferably from 0.1 mm to 0.2 mm, and the decrease rate of the residual magnetization is 1% or less. When the thickness dimension in the direction of the axis of easy magnetization is within the range described above, the decrease rate of the residual magnetization is further reduced.

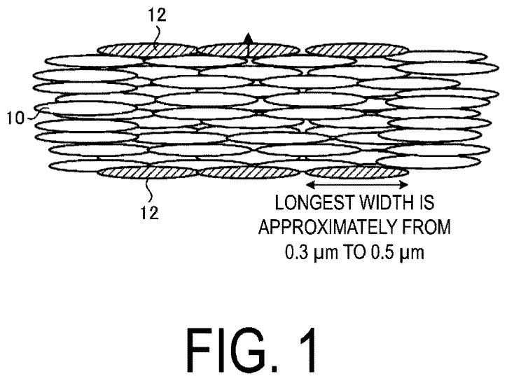

In the rare earth magnet according to the embodiment, the reason why the decrease rate of the residual magnetization is reduced even if the thickness dimension is small is considered as below. FIG. 1 is a diagram schematically illustrating a cross-sectional view in a thickness direction of a rare earth magnet according to an embodiment. In the rare earth magnet according to the embodiment, a crystal grain 10 having a flat shape is stacked so that the minor axis direction (axis of easy magnetization) is aligned with the thickness direction of the rare earth magnet being a flat plate. Note that in FIG. 1, an upward arrow indicates the direction of the axis of easy magnetization. In the grinding step, since the surface in the direction perpendicular to the thickness direction of the flat plate is processed, crystal grains exposed at the processed surface after processing deteriorate. In FIG. 1, the crystal grain is illustrated as a crystal grain 12 to be deteriorated by grinding. In the rare earth magnet according to the embodiment, a decrease rate of the residual magnetization is thought to be reduced because the portion occupied by the crystal grains 12 to be deteriorated by grinding is small.

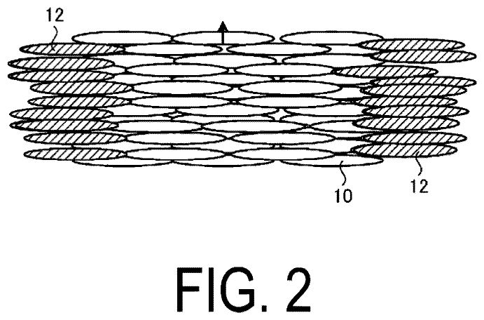

On the other hand, FIG. 2 is a diagram schematically illustrating a cross-sectional view in the thickness direction of the rare earth magnet obtained in a case where a surface parallel to the thickness direction of the flat plate is processed in the grinding step. Note that, in FIG. 2, an upward arrow indicates the direction of the axis of easy magnetization. In the above-mentioned case, the decrease rate of the residual magnetization is thought to be difficult to be reduced because the portion occupied by the crystal grains 12 to be deteriorated by grinding is increased. From the above, since the crystal grain 10 has a flat shape, the deterioration caused by processing is reduced when the axis of easy magnetization and the processed surface are aligned as in the rare earth magnet according to the embodiment, and the decrease rate of the residual magnetization is thought to be reduced.

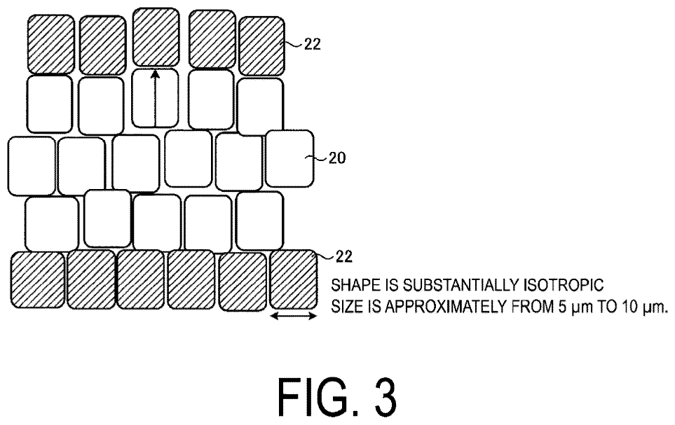

In addition, as a comparison, a case where a magnet having the same size as the rare earth magnet according to the embodiment is obtained by grinding the Nd sintered magnet will be described. FIG. 3 is a diagram schematically illustrating a cross-sectional view in a thickness direction of the Nd sintered magnet subjected to the grinding step. Note that in FIG. 3, an upward arrow indicates the direction of the axis of easy magnetization. A crystal grain 20 of the Nd sintered magnet has a substantially isotropic shape. In the grinding step, processing is performed in the direction of the axis of easy magnetization. The crystal grain exposed at the processed surface after processing is deteriorated. In FIG. 3, the crystal grain is illustrated as a crystal grain 22 to be deteriorated by grinding. In the Nd sintered magnet, the decrease rate of the residual magnetization is thought to increase because a portion occupied by the crystal grains 22 to be deteriorated by grinding is large. Note that since the shape of the crystal grain 20 of the Nd sintered magnet is substantially isotropic, the deterioration caused by grinding is thought to be independent of the axis of easy magnetization and the processed surface.

As described above, since an alloy thin film layer is not required to be formed on the surface, or the heat treatment is not required, the rare earth magnet according to the embodiment is excellent in workability during manufacturing. In addition, even if the thickness dimension is small, the decrease rate of the residual magnetization is reduced, and high performance is achieved. Accordingly, the rare earth magnet according to the embodiment is suitable as a magnet for an ultra-small and thin motor, an ultra-small and thin magnetic actuator, or the like.

### EXAMPLES

### Production of Test Piece of Example

As described above, a sintered magnet body was produced by using Nd—Fe—B-based magnet powder (having a structure of the main phase containing the R₂Fe₁₄B compound) and by subjecting the Nd—Fe—B-based magnet powder to hot press step, and a hot-deformed magnet was produced by subjecting the sintered magnet body to hot plastic processing. Subsequently, the hot-deformed magnet obtained by the hot plastic processing was cut out into a sample piece having a predetermined flat plate shape (3 mm×3 mm). Here, the test piece was cut out so that the thickness direction of the flat plate is aligned with the thickness direction (pressure direction during production of the hot-deformed magnet, namely, direction of the axis of easy magnetization) of the hot-deformed magnet. Subsequently, a sample piece (3 mm×3 mm×thickness t) was produced by grinding. Specifically, test specimens were produced by changing the thickness t of the sample pieces to 0.5 mm, 0.2 mm, 0.1 mm, and 0.07 mm. Note that the test piece was a rare earth magnet having a structure of a main phase containing an R₂Fe₁₄B compound and an axis of easy magnetization being oriented in a minor axis direction of a crystal grain of the main phase. The average crystal grain size of the main phase was from 0.02 μm to 0.5 μm.

### Production of Test Piece for Comparison

Test pieces for comparison were produced by using Sample A and Sample B. Sample A and Sample B are both Nd—Fe—B-based sintered magnets available from Shin-Etsu Chemical Co., Ltd. and have magnetic anisotropy, and Sample A has a product number of N50, and Sample B has a product number of N39UH. A sample piece having a predetermined shape (3 mm×3 mm) was cut out from a block having the predetermined shape. Here, the test piece was cut out so that the thickness direction of the flat plate is aligned with the direction of the axis of easy magnetization. Subsequently, a sample piece (3 mm×3 mm×thickness t) was produced by grinding. Specifically, test pieces having different thicknesses t of 0.5 mm, 0.2 mm, 0.1 mm, and 0.07 mm were produced.

### Measurement of Magnetic Properties

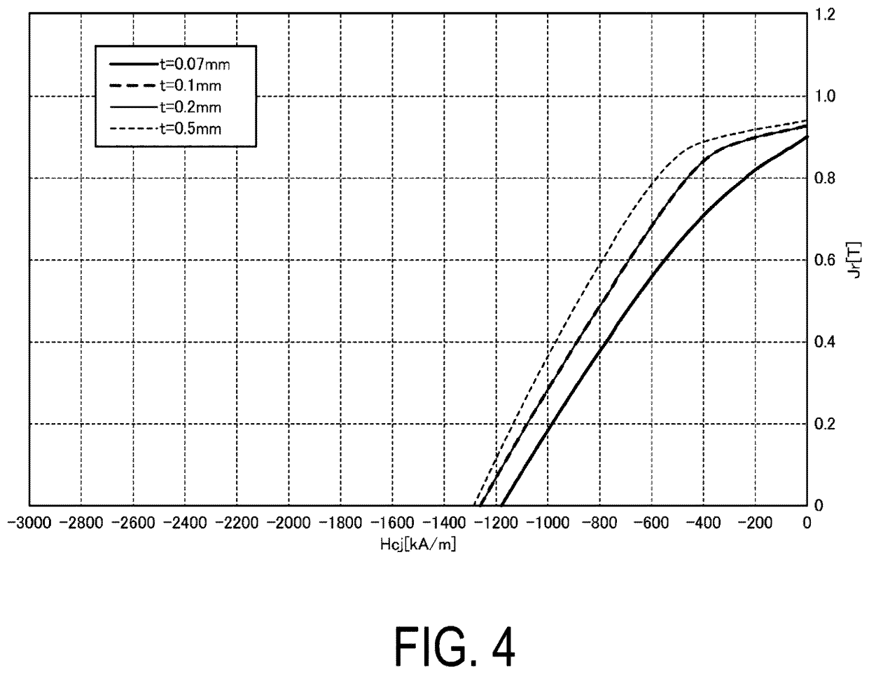

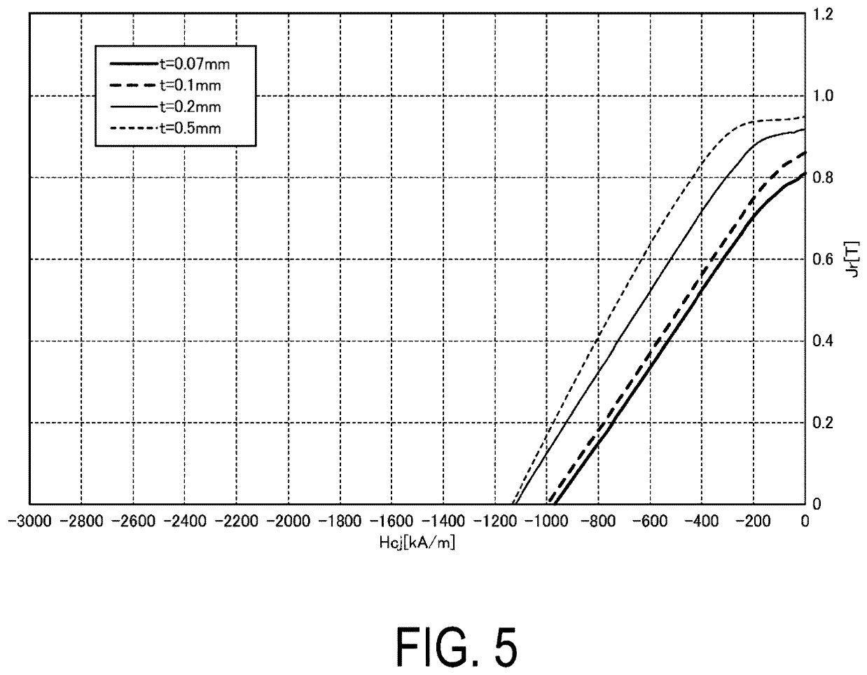

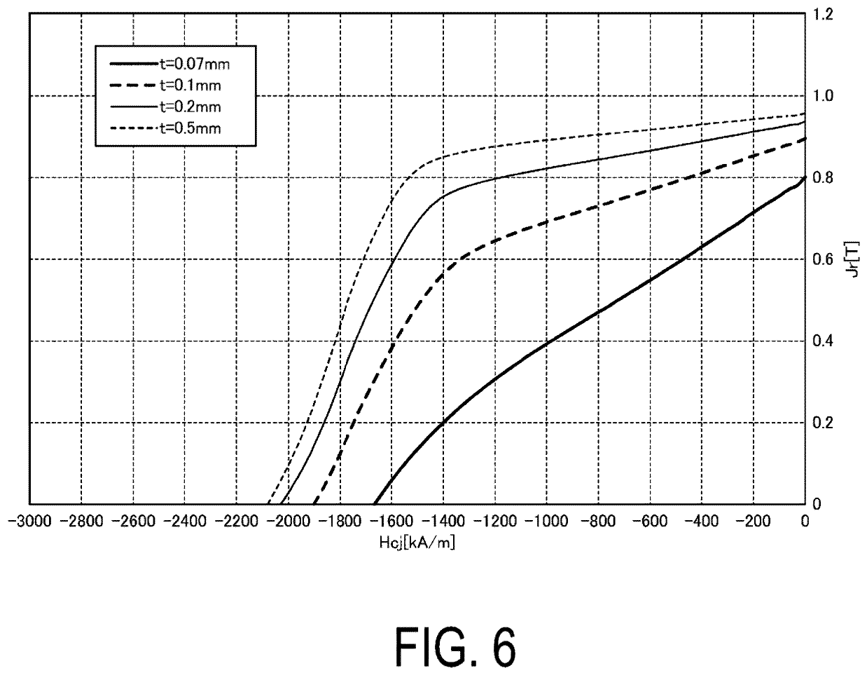

The magnetic properties of the sample pieces were measured with a vibrating sample magnetometer (VSM) after each of the sample pieces having been magnetized in the thickness direction (direction of axis of easy magnetization) of the sample piece by applying a magnetic field of 5 T to each of the sample pieces. The results are shown in FIGS. 4 to 6. Namely, FIG. 4 shows demagnetization curves of test pieces of Example, FIG. 5 shows demagnetization curves of test pieces of Comparative Example (test pieces produced by using Sample A), and FIG. 6 shows demagnetization curves of test pieces of Comparative Example (test pieces produced by using Sample B).

As shown in FIGS. 4 to 6, in both of the test pieces of Example and the test pieces of Comparative Example, if the thickness of the test piece is small as compared with 0.5 mm, deterioration is observed in both residual magnetization and intrinsic coercivity. Table 1 shows the ratio of the values of the magnetic properties (residual magnetization) when the thickness of the test piece is 0.2 mm, 0.1 mm, and 0.07 mm with respect to the magnetic properties (residual magnetization) when the thickness of the test piece is 0.5 mm. Table 2 shows the decrease rate of the residual magnetization.

As shown Table 1, in the test piece of Example, the decrease rate of the residual magnetization was 99% even in a case where the thickness of the sample is 0.2 mm and also even in a case where the thickness of the sample is 0.1 mm, and almost no deterioration was observed. In a case where the thickness of the sample is 0.07 mm, the decrease rate of the residual magnetization is 95% and is slightly deteriorated. In contrast, in the test pieces of Comparative Example (test piece produced by using Sample A and the test piece produced by using Sample B), the decrease rate of the residual magnetization was 97% in a case of a thickness of 0.2 mm, and 83% in a case of a thickness of 0.07 mm, and significant deterioration was confirmed.

As described above, the test piece of Example is found to be a high-performance rare earth magnet since the decrease rate of the residual magnetization is kept about 5% when the thickness of the processed magnet is up to 0.07 mm, and almost no decrease rate in residual magnetization is found when the thickness of the processed magnet is up to 0.1 mm. Accordingly, as described above, the test piece of Example is suitable as a magnet of an ultra-small and thin motor, an ultra-small and thin magnetic actuator, or the like.

TABLE 1

| Thickness t | 0.5 mm | 0.2 mm | 0.1 mm | 0.07 mm |
|---|---|---|---|---|
| Test piece of Example | 100% | 99% | 99% | 95% |
| Test piece of Comparative | 100% | 97% | 89% | 83% |
| Example (using Sample A) | | | | |
| Test piece of Comparative | 100% | 97% | 93% | 83% |
| Example (using Sample B) | | | | |

TABLE 2

| Thickness t | 0.2 mm | 0.1 mm | 0.07 mm |
|---|---|---|---|
| Test piece of Example | 1% | 1% | 5% |
| Test piece of Comparative | 3% | 11% | 17% |
| Example (using Sample A) | | | |
| Test piece of Comparative | 3% | 7% | 17% |
| Example (using Sample B) | | | |

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

1. A rare earth magnet obtained by subjecting an R—Fe—B-based alloy containing R, wherein R represents a rare earth element containing Nd, Fe, and B to hot plastic processing,
wherein the rare earth magnet has a structure of a main phase containing an R₂Fe₁₄B compound,
an axis of easy magnetization is oriented in a minor axis direction of a crystal grain of the main phase,
a thickness dimension in a direction of the axis of easy magnetization is from 0.07 mm to 0.2 mm, and
a decrease rate of residual magnetization is 5% or less, wherein the decrease rate (%) of the residual magnetization is a rate of decrease in residual magnetization with respect to when residual magnetization of the rare earth magnet having the thickness dimension of 0.5 mm is defined as 100%.

2. The rare earth magnet according to claim 1,
wherein an average crystal grain size of the main phase is from 0.02 μm to 0.5 μm.

3. The rare earth magnet according to claim 1,
wherein a thickness dimension of the rare earth magnet is from 0.1 mm to 0.2 mm.

4. The rare earth magnet according to claim 1,
wherein the rare earth magnet has a flat plate shape.
